(19) United States
(12) Patent Application Publication
(10) Pub. No.: US 2026/0250073 A1
(43) Pub. Date: Aug. 27, 2026

(54) AUTOMATIC HORIZONTAL AND VERTICAL BUTT WELDING APPARATUS AND METHOD THEREOF FOR EXPANDABLE PROFILE LINERS

(71) Applicant: SHENZHEN UNIVERSITY, Shenzhen (CN)

(72) Inventors: Le ZHAO, Shenzhen (CN); Meng XU, Shenzhen (CN); Chao YUAN, Shenzhen (CN); Pengfei CUI, Shenzhen (CN); Guikang LIU, Shenzhen (CN)

(21) Appl. No.: 19/539,006

(22) Filed: Feb. 13, 2026

(30) Foreign Application Priority Data
Feb. 20, 2025 (CN) 202510188306.2

(51) Int. Cl. B65G 17/08; B29C 65/00; B65G 21/20; E21B 19/00; E21B 23/00; E21B 43/10; E21B 43/12

(52) U.S. Cl. CPC B65G 17/08; B29C 66/73921; B65G 21/2072; E21B 19/00; E21B 23/00; E21B 43/10; E21B 43/126

(57) ABSTRACT

An automatic horizontal and vertical butt welding apparatus and method thereof for expandable profile liners are provided. The apparatus includes a bracket functioning as a basic lifting frame, where both lower sides of the bracket are respectively provided with horizontal clamping mechanisms for horizontally positioning expandable profile liners, a clamping and butt-joining mechanism for welding two interfaces of the expandable profile liners is arranged between the two horizontal clamping mechanisms, upper and lower sides of the clamping and butt-joining mechanism are respectively provided with vertical clamping mechanisms for vertically positioning the expandable profile liners, the clamping and butt-joining mechanism is rotatably connected to an adjustment mechanism for controlling a rotation angle of the clamping and butt-joining mechanism, the adjustment mechanism is fixedly connected to a driving mechanism, and the driving mechanism is fixedly connected to the bracket.

### CROSS-REFERENCE TO RELATED APPLICATIONS

This application claims priority to Chinese Patent Application No. 202510188306.2, filed on February 20, 2025, the contents of which are hereby incorporated by reference.

### TECHNICAL FIELD

The present disclosure relates to petroleum and natural gas drilling engineering, geothermal drilling engineering, and geological drilling engineering, etc., specifically to the technical field for addressing technical challenges in mitigating lost circulation in complex formations or wellbore instability in trouble well sections, and in particular relates to an automatic horizontal and vertical butt welding apparatus and method thereof for expandable profile liners.

### BACKGROUND

Expandable profile liner technology has critical and widespread applications in the field of petroleum and natural gas drilling engineering, and may mitigate drilling fluid loss (especially severe losses in large fractures and caverns), isolate unstable collapsed well sections, and repair damaged casing liners without altering the wellbore structure or reducing the hole size. Expandable profile liner technology involves cold pressing a round pipe to form a “FIGURE-8 corrugated” cross-section, thereby reducing the diameter of the round pipe to ensure smooth passage through the upper well sections to the target formation. During expandable profile liner installation, multiple expandable profile liners must be welded together to form a continuous liner string based on the target well section length, which is then deployed downhole. Subsequently, hydraulic expansion and mechanical shaping process are employed to expand the profile liner string into a round shape and tightly adhere to the wellbore wall, achieving precise sealing of complex formations. Therefore, the welding quality of multiple welds directly determines the strength and reliability of the expandable profile liner string.

When aligning and welding expandable profile liners before lowering the string into the well, to improve construction efficiency, horizontal butt welding of two liners is usually performed on the ground at the wellsite first. The expandable profile liners are then hoisted to the wellhead for transverse (vertical) welding with the profile liner that has been partially lowered into the well. However, manual string alignment and welding remain predominantly relied upon at present. This process has shortcomings such as low welding precision, high labor intensity, and elevated safety risks. Moreover, welding quality excessively depends on the experience and skill of the welder, making it difficult to ensure uniform welding strength and quality. Welding defects such as slag inclusion, porosity, misalignment, and lack of penetration are prone to occur, seriously compromising the overall performance of the profile liner string.

Therefore, there is an urgent need for an automatic horizontal and vertical butt welding apparatus and method thereof for expandable profile liners technology, which may improve the automation level of butt welding operations, ensure welding precision, reduce worker labor intensity, and safeguard the safety of operating personnel.

### SUMMARY

An objective of the present disclosure is to provide an automatic horizontal and vertical butt welding apparatus and method thereof for expandable profile liners, to solve the problems existing in the prior art mentioned above.

To achieve the above objective, the present disclosure provides the following solutions. An automatic horizontal and vertical butt welding apparatus for expandable profile liners includes a bracket functioning as a basic lifting frame, where both lower sides of the bracket are respectively provided with horizontal clamping mechanisms for horizontally positioning expandable profile liners, a clamping and butt-joining mechanism for welding two interfaces of the expandable profile liners is arranged between the two horizontal clamping mechanisms, upper and lower sides of the clamping and butt-joining mechanism are respectively provided with vertical clamping mechanisms for vertically positioning the expandable profile liners, the clamping and butt-joining mechanism is rotatably connected to an adjustment mechanism for controlling a rotation angle of the clamping and butt-joining mechanism, the adjustment mechanism is fixedly connected to a driving mechanism, and the driving mechanism is fixedly connected to the bracket.

In some embodiments, each of the horizontal clamping mechanisms includes a lifting frame having X-shaped supports symmetrically disposed therein. Lower ends of the X-shaped supports are slidably connected to a bottom portion of the lifting frame, while upper ends thereof are slidably connected to a top plate. A first clamping part is disposed on the top plate at an end distal from the X-shaped supports.

In some embodiments, the upper ends of the X-shaped supports are fixedly connected to a piston rod of a first hydraulic cylinder. A cylinder body of the first hydraulic cylinder is fixedly mounted to the bottom portion of the lifting frame, with the first hydraulic cylinder positioned at an oblique angle.

In some embodiments, the first clamping part comprises a first support plate fixedly connected to the top plate. A fixed ring of a first annular guide rail is fixedly mounted within the first support plate, and first pneumatic grippers are symmetrically disposed on an inner wall of a first movable ring positioned within the first annular guide rail.

In some embodiments, the clamping and butt-joining mechanism includes a third support plate rotatably connected to the adjustment mechanism. A distal end of the third support plate is internally provided with fixed rings of third annular guide rails symmetrically disposed therein, and third pneumatic grippers are symmetrically mounted on inner walls of third movable rings within the respective third annular guide rails.

In some embodiments, a manipulator is mounted on the distal end of the third support plate, and an automated welding torch is installed on a distal end of the manipulator.

In some embodiments, each vertical clamping mechanism comprises a second support plate slidably connected to the bracket. A distal end of the second support plate is internally provided with a fixed ring of a second annular guide rail, and second pneumatic grippers are symmetrically mounted on an inner wall of a second movable ring within the second annular guide rail.

In some embodiments, the adjustment mechanism comprises a movable block slidably connected to the bracket. A first end of the movable block facing the third support plate is fixedly connected to a stationary base of an electric turntable, and a rotatable platform of the electric turntable is fixedly connected to the third support plate.

In some embodiments, the driving mechanism comprises a chain conveyor belt configured to control vertical movement of the third support plate. The chain conveyor belt is installed on a side of the bracket opposite to the third support plate, and the movable block is fixedly connected to a chain of the chain conveyor belt.

An automatic horizontal and vertical butt welding method for expandable profile liners includes the following steps:

S1, determining a required number of expandable profile liners based on a length of a complex isolation well section, and performing horizontal welding on the expandable profile liners in pairs;

S2, positioning two expandable profile liners in the respective horizontal clamping mechanisms, and leveling the horizontal clamping mechanisms such that central axes of the two expandable profile liners are coaxially aligned;

S3, cleaning beveled edges of the two expandable profile liners to be welded;

S4, inserting the two expandable profile liners into the clamping and butt-joining mechanism, while maintaining a predetermined welding gap between the beveled edges of the two expandable profile liners to be welded;

S5, performing automated horizontal welding through the clamping and butt-joining mechanism;

S6, upon completion of horizontal welding, removing the welded expandable profile liner assembly, then repeating steps S2 through S5 to obtain multiple welded expandable profile liner strings;

S7, relocating the welding apparatus to a wellhead location, and configuring the clamping and butt-joining mechanism for vertical welding operations;

S8, lowering a first end of one welded expandable profile liner string into the wellhead, then securing a second end thereof to a lower vertical clamping mechanism;

S9, positioning another welded expandable profile liner string on an upper vertical clamping mechanism of the clamping and butt-joining mechanism;

S10, cleaning the beveled edges at opposing ends of the two welded expandable profile liner strings;

S11, performing automated vertical welding through the clamping and butt-joining mechanism, conducting non-destructive testing to verify weld quality, and lowering the welded assembly into the well upon quality confirmation;

S12, upon completion of vertical welding, lowering the welded assembly into the well through the wellhead, securing the protruding end with the lower vertical clamping mechanism, installing a subsequent welded expandable profile liner string on the upper vertical clamping mechanism, and continuing vertical welding operations; and

S13, repeating steps S10 through S12 until all expandable profile liner strings are vertically welded and deployed downhole, then proceeding with subsequent downhole operations.

The present disclosure provides the following technical advantages.

The present disclosure enables precise horizontal alignment and positioning of expandable profile liners through the horizontal clamping mechanisms, and accurate vertical positioning of liner end faces during downhole deployment through the vertical clamping mechanisms. The clamping and butt-joining mechanism facilitates high-quality welding operations for expandable profile liners. This disclosure achieves high-precision automated welding in both horizontal and vertical orientations, enabling precise pipe alignment and automated butt welding while improving welding accuracy, reducing operator workload, and enhancing personnel safety.

### BRIEF DESCRIPTION OF THE DRAWINGS

In order to explain the embodiments of the present disclosure or the technical solution in the prior art more clearly, the drawings needed in the embodiments will be briefly introduced below. Apparently, the drawings in the following description are only some embodiments of the present disclosure. For one of ordinary skill in the art, other drawings may be obtained according to these drawings without creative effort.

FIG. 1 is a front elevational view of the welding apparatus according to the present disclosure.

FIG. 2 is a perspective schematic view of the welding apparatus in a horizontal welding configuration.

FIG. 3 is a perspective schematic view of the welding apparatus in a vertical welding configuration.

FIG. 4 is a detailed view of the first annular guide rail according to the present disclosure.

FIG. 5 is a detailed view of the second annular guide rail according to the present disclosure.

FIG. 6 is a detailed view of the third annular guide rail according to the present disclosure.

FIG. 7 is a partial sectional view of the welding apparatus during vertical welding operations.

FIG. 8 is a flowchart illustrating the automated horizontal and vertical butt welding method for expandable profile liners according to the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure more clear and easier to understand, the present disclosure will be further described in detail with the attached drawings and specific embodiments.

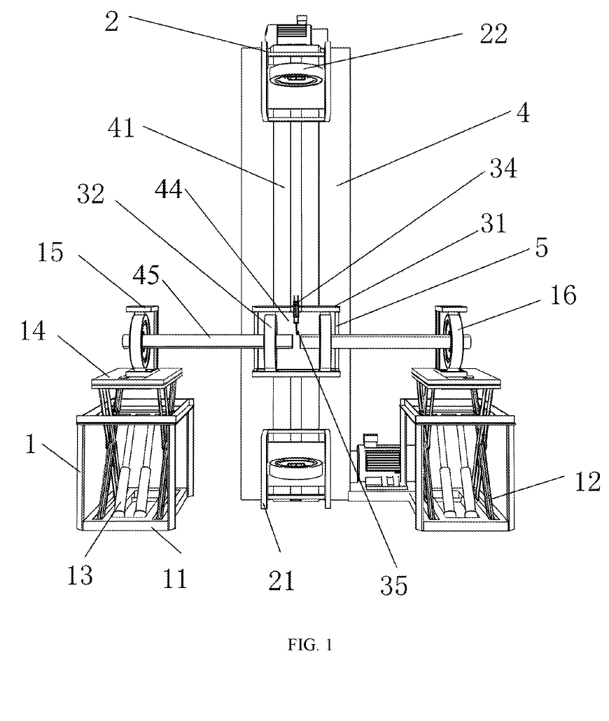

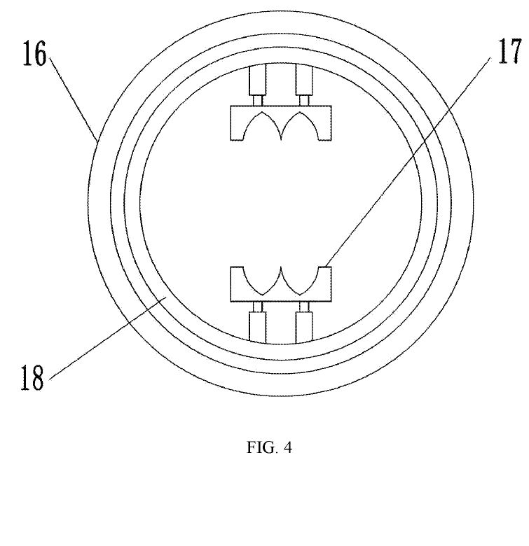

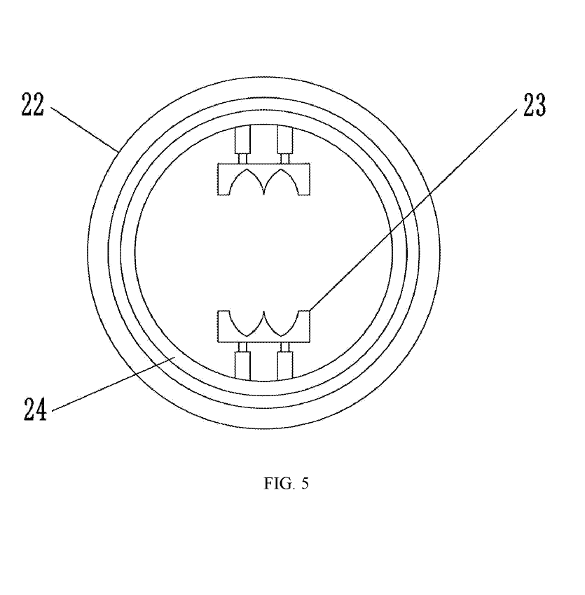

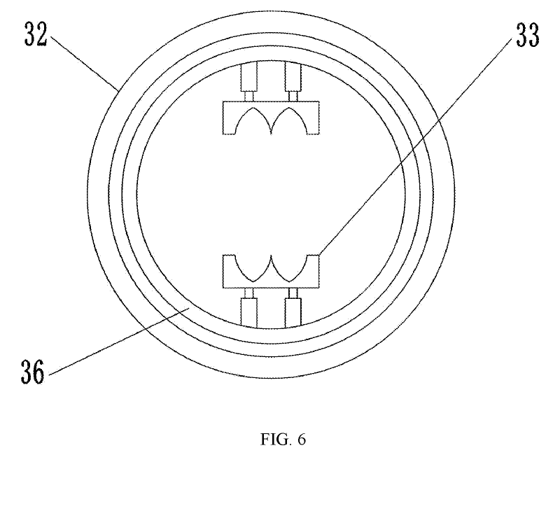

With reference to FIG. 1 to FIG. 7, the present disclosure provides automated horizontal and vertical butt welding apparatus for expandable profile liners, including a bracket 4 functioning as a main support frame. Both lower sides of the bracket 4 are respectively provided with horizontal clamping mechanisms 1 for horizontally positioning expandable profile liners 45. A clamping and butt-joining mechanism 3 for welding the interfaces of two expandable profile liners 45 is arranged between the two horizontal clamping mechanisms 1. The upper and lower sides of the clamping and butt-joining mechanism 3 are respectively provided with vertical clamping mechanisms 2 for vertically positioning the expandable profile liners 45. The clamping and butt-joining mechanism 3 is rotatably connected to an adjustment mechanism for controlling the rotation angle of the clamping and butt-joining mechanism 3. The adjustment mechanism is fixedly connected to a driving mechanism, and the driving mechanism is fixedly connected to the bracket 4.

The horizontal clamping mechanisms 1 are used for horizontally positioning the expandable profile liners; and the clamping and butt-joining mechanism 3 is used to perform horizontal automated welding operations.

The vertical clamping mechanisms 2 are used for vertically positioning the expandable profile liners; and the clamping and butt-joining mechanism 3 is employed to perform vertical automated welding operations.

The present disclosure employs the horizontal clamping mechanisms 1 to horizontally position two expandable profile liners, utilizes the vertical clamping mechanisms 2 to position two expandable profile liners in the vertical direction, and employs the clamping and butt-joining mechanism 3 to weld the two expandable profile liners. The present disclosure may effectively perform welding operations on the expandable profile liners in both horizontal and vertical directions, improve the automation level of pipe alignment and welding machinery, enhance welding precision, reduce worker labor intensity, and safeguard the safety of operating personnel.

The present disclosure, through system integration and cooperative control, effectively achieves high-precision automated welding of expandable profile liners in both horizontal and vertical directions.

Concepts of System Integration and Cooperative Control: System Integration refers to the practice of combining software, hardware, and communication technologies to solve information processing problems for users. The various separate components of the integration are originally independent systems. Through system integration, these components may work together organically and coordinately to achieve overall benefits and realize overall optimization. Cooperative Control is a control strategy aimed at achieving efficient system operation of a system through mutual cooperation among multiple subsystems. In control systems, cooperative control theory is based on the principle of overall optimization. By designing appropriate control strategies, the subsystems may cooperate and work together to maximize the performance of the entire system.

System integration and cooperative control are complementary. System integration provides the hardware and software infrastructure, enabling the subsystems to communicate and cooperate with each other. Cooperative control, building on this foundation, achieves collaborative work among the subsystems by designing control algorithms and strategies to achieve the overall optimization goal of the system.

The present disclosure, through system integration and cooperative control, enables the horizontal clamping mechanisms 1, vertical clamping mechanisms 2, and clamping and butt-joining mechanism 3 to work cooperatively, effectively achieving high-precision automated welding of expandable profile liners in both horizontal and vertical directions.

In an embodiment, each of the horizontal clamping mechanisms 1 includes a lifting frame 11. X-shaped supports 12 are symmetrically arranged within the lifting frame 11. Lower ends of the X-shaped supports 12 are slidably connected to the bottom of the lifting frame 11, while the upper ends thereof are slidably connected to a top plate 14. A first clamping part is disposed on the top plate 14 at an end distal from the X-shaped supports 12. The X-shaped supports 12 may drive the top plate 14 to lift.

In an embodiment, the upper ends of the X-shaped supports 12 are fixedly connected to a piston rod of a first hydraulic cylinder 13. A cylinder body of the first hydraulic cylinder 13 is fixedly mounted to the bottom portion of the lifting frame 11. The first hydraulic cylinder 13 is arranged obliquely. The extension and retraction of the piston rod drive the X-shaped supports 12 to move. Through the expansion or contraction of the X-shaped supports 12, the X-shaped supports 12 may stably drive the top plate 14 to lift.

In an embodiment, the first clamping part includes a first support plate 15 fixedly connected to the top plate 14. A fixed ring of a first annular guide rail 16 is fixedly mounted within the first support plate 15. First pneumatic grippers 17 are symmetrically and fixedly connected on the inner wall of a first movable ring 18 within the first annular guide rail 16. The first pneumatic grippers 17 may effectively clamp and position the expandable profile liners in a horizontal state.

In an embodiment, the clamping and butt-joining mechanism 3 includes a third support plate 31 rotatably connected to the adjustment mechanism. Fixed rings of third annular guide rails 32 are symmetrically disposed within a distal end of the third plate 31 away from the adjustment mechanism. Third pneumatic grippers 33 are symmetrically and fixedly connected on the inner wall of a third movable ring 36 within the third annular guide rail 32. After the opposing ends of two expandable profile liners are tightly abutted, the two third pneumatic grippers 33 may effectively clamp and position the two expandable profile liners, preventing the separation of the opposing ends of the two expandable profile liners and facilitating welding.

In an embodiment, a manipulator 34 is mounted on the distal end of the third support plate 31 away from the adjustment mechanism. An automated welding torch 35 is installed on a distal end of the manipulator 34. The manipulator 34 may effectively drive the automated welding torch 35 to perform stable welding at the welding position.

The manipulator 34 is a mechanical device capable of simulating human arm movements, typically used for automated operations in industrial production. The manipulator 34 may perform various tasks such as grasping, handling, assembling, welding, etc., and may replace human work in hazardous environments, improving production efficiency and quality.

The manipulator 34 typically includes an execution mechanism, a control system, and a position detection device.

The execution mechanism includes components such as the hand, wrist, arm, and body, sometimes with a walking mechanism. Drive systems commonly include four forms: hydraulic transmission, pneumatic transmission, electric transmission, and mechanical transmission.

The control system directs the manipulator to move according to a prescribed program and stores the command information given to the manipulator.

The position detection device controls the movement position of the manipulator's execution mechanism and continuously provides feedback on the actual position of the execution mechanism to the control system.

When the manipulator 34 utilizes an Asea Brown Boveri (ABB) robot and the automated welding torch 35 employs a fiber laser multi-axis welding machine working in coordination, the manipulator 34 may perform actions such as automated recognition, positioning, and welding, resulting in high positioning accuracy, sensitive response, and shock resistance, thereby improving welding quality.

In an embodiment, each of the vertical clamping mechanisms 2 includes a second support plate 21 slidably connected to the bracket 4. A fixed ring of a second annular guide rail 22 is fixedly mounted within a distal end of the second support plate 21 away from the bracket 4. Second pneumatic grippers 23 are symmetrically and fixedly connected on the inner wall of a second movable ring 24 within the second annular guide rail 22. The second pneumatic grippers 23 may effectively clamp and position the expandable profile liners in a vertical state.

To adjust the height of the second support plate 21, the second support plate 21 is fixedly connected to a piston rod of a second hydraulic cylinder. A cylinder body of the second hydraulic cylinder is fixedly mounted to the bracket 4. The extension and retraction of the piston rod drive the second support plate 21 to move, enabling the second hydraulic cylinder to adjust the position of the second support plate 21.

An annular guide rail is a guide rail system designed for circular motion, typically consisting of a precision annular guide rail and a ring segment. This guide rail system may achieve 360 degrees (°) or segmented motion and is suitable for a wide range of applications in various industries. The load range of annular guide rails is typically between 0-9300 Newtons (N), and the speed range is between 0 - 5 meters per second (m/s).

When the annular guide rail is circular, the ring segment moves along the inner wall of the annular guide rail, causing the ring segment to perform circular movement.

Annular guide rails achieve high precision through initial positioning and repeat positioning. Initial positioning is achieved by a servo drive sending pulses to drive the motor to move the station close to the positioning pin. During secondary positioning, a side cylinder and solenoid valve actuate to extend the positioning cylinder, and then the positioning pin rotates for secondary positioning of the station, achieving high-precision repeat positioning.

In an embodiment, the adjustment mechanism includes a movable block 42 slidably connected to the bracket 4. A first end of the movable block 42 facing the third support plate 31 is fixedly connected to a stationary base of an electric turntable 44. A rotatable platform of the electric turntable 44 is fixedly connected to the third support plate 31. The electric turntable 44 drives the third support plate 31 to rotate relative to the movable block 42, enabling the third support plate 31 to operate in either a horizontal state or a vertical state. When the third support plate 31 is in a horizontal state, automated welding on horizontally positioned expandable profile liners may be performed. When the third support plate 31 is in a vertical state, automated welding on vertically positioned expandable profile liners may be performed.

An electric turntable is employed to rotate various objects or workpieces. The electric turntable is widely utilized in industrial automation production lines, logistics and warehousing systems, exhibition displays, and other fields. The electric turntable, driven by a motor, enables the rotational movement of the objects, allowing the objects to rotate 360° on a horizontal plane, facilitating observation or operation of the objects from different angles.

Working principle of the electric turntable: the working principle of an electric turntable primarily encompasses three aspects: motor drive, gear transmission, and control system.

Motor drive: the core of the electric turntable is the motor, which converts electrical energy into mechanical energy to drive the turntable to rotate. Common motor types include direct current (DC) motors and alternating current (AC) motors. DC motors control speed and direction by adjusting voltage or current, while AC motors achieve the same effect by changing the frequency and phase of the voltage. The motor is typically connected to the turntable via a shaft and transmission device.

Gear transmission: gear transmission is a commonly employed transmission mechanism in electric turntables, used to convert the high-speed rotation of the motor into the relatively low-speed rotation of the turntable. Gear transmission consists of one or more pairs of gears. One gear is connected to the motor shaft, called the driving gear, and the other gear is connected to the turntable shaft, called the driven gear. When the driving gear rotates, torque and speed are transmitted through the gear system to drive the driven gear and turntable to rotate. The size and number of teeth of the gears may be designed as needed to achieve the required speed and torque ratio.

Control system: an electric turntable employed requires a control system to control the rotation direction, speed, stopping, and other operations. This control system may be as simple as using a switch to control the start and stop of the motor, or as complex as using a computer or programmable logic controller to achieve fine control. In some application scenarios, the rotation speed of the electric turntable may even be measured and adjusted in real-time through sensors to achieve higher precision and stability.

In an embodiment, the driving mechanism comprises a chain conveyor system, such as a chain conveyor belt 43. The chain conveyor belt 43 is configured to control vertical movement of the third support plate 31. The chain conveyor belt 43 is installed on a side of the bracket 4 opposite to the third support plate 31. The chain conveyor belt 43 is installed inside one side of the bracket 4 away from the third support plate 31. The movable block is fixedly connected to the chain of the chain conveyor belt 43. The chain of the chain conveyor belt drives the movable block to rise or descend. The movable block 42 is fixedly connected to a chain of the chain conveyor belt 43, enabling vertical movement of the third support plate 31 through the electric turntable 44.

The chain conveyor belt includes a chain structure, a metal mesh structure, a connection structure, and an attachment structure, a drive structure, a support structure, a tensioning structure, a lubrication system, and a control system.

The chain structure: the chain is the primary component of the chain conveyor belt, typically composed of multiple chain links. Each chain link includes components such as an inner link plate, an outer link plate, a pin shaft, and a roller. The inner plate and outer link plate are connected by a pin shaft, and the roller is sleeved on the pin shaft, allowing the chain to roll smoothly on the sprockets.

The metal mesh structure: the metal mesh is the load-bearing component of the chain conveyor belt, typically woven from metal wires, with excellent breathability and wear resistance. The mesh size and configuration of the metal mesh may be customized according to needs to meet the conveying requirements of different materials.

The connection structure: the connection structure of the chain conveyor belt typically employs methods such as insertion plates or specially-shaped connection plates to connect the support rods with the chains. This connection method has good structural strength and load-bearing capacity, and the installation process is straightforward, saving labor.

The attachment structure: to meet different conveying needs, the chain conveyor belt may also be equipped with various attachments, such as baffles, edges, and carrier belts. These attachments may effectively prevent materials from sliding off or overflowing during the conveying process, improving conveying efficiency and safety.

The drive structure: the chain conveyor belt is usually driven by sprockets. The meshing method between the sprockets and the chain may be link plate-to-sprocket tooth meshing or roller (or sleeve)-to-sprocket tooth meshing. The rotation of the driving sprocket drives the cyclic movement of the chain, thereby achieving material conveying.

The support structure: the chain conveyor belt requires a support structure during operation to maintain the normal running trajectory of the chain. The support structure may be tracks or rollers, etc. They may bear the weight of the chain and materials and guide the movement direction of the chain.

The tensioning structure: to ensure the normal operation of the chain conveyor belt, a tensioning device is typically required to adjust the tightness of the chain. The tensioning device may be a screw tensioner, spring tensioner, or counterweight tensioner, etc. They may automatically or manually adjust the tension of the chain to prevent the chain from becoming loose or excessively tight.

The lubrication system: to reduce wear between the chain and sprockets, the chain conveyor belt typically needs to be equipped with a lubrication system. The lubrication system may be drip lubrication, spray lubrication, or oil bath lubrication, which may effectively reduce the friction coefficient between the chain and sprockets and extend their service life. Protection devices: to protect the safety of operating personnel and prevent material spillage, the chain conveyor belt typically needs to be equipped with protection devices such as protective covers and guardrails. These protection devices may effectively prevent accidents and improve workplace safety.

The control system: modern chain conveyor belts are typically equipped with a control system capable of automated operation and monitoring. The control system may include motor controllers, sensors, programmable logic controllers (PLCs), and other equipment, enabling functions such as starting, stopping, speed adjustment, and fault diagnosis of the chain conveyor belt.

Linear guide rails 41 are mounted on the bracket 4 to ensure stable movement of the second support plate 21, third support plate 31, and movable block 42 along predetermined paths.

A guide rail is a mechanical component used to support and guide moving parts to perform reciprocating linear motion in a given direction. The guide rail plays a crucial role in modern industrial automation and precision machinery fields. Guide rails may be classified into various types, including linear guide rails, roller linear guide rails, cylindrical linear guide rails, ball linear guide rails, etc.

To enable the first pneumatic grippers 17, second pneumatic grippers 23, and third pneumatic grippers 33 to effectively clamp the expandable profile liners, clamping force sensors are respectively installed on the first pneumatic grippers 17, second pneumatic grippers 23, and third pneumatic grippers 33. By monitoring the clamping force through the clamping force sensors, excessive deformation of the expandable profile liners due to excessive clamping force may be effectively avoided.

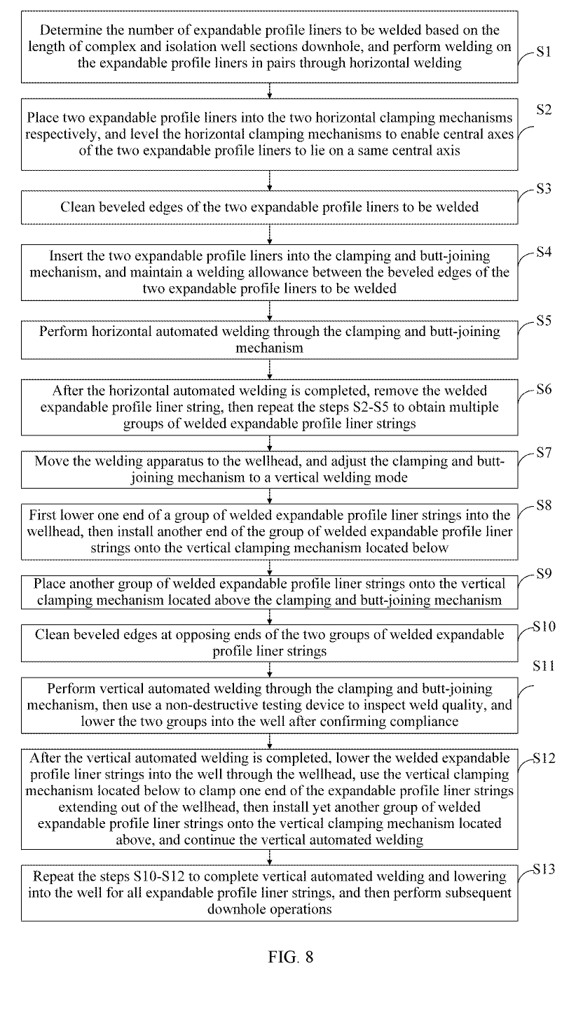

As shown in FIG. 8, an automated horizontal and vertical butt welding method for expandable profile liners includes the following steps:

S1, determining the number of expandable profile liners to be welded based on the length of the complex well section requiring treatment, and performing horizontal welding by joining the expandable profile liners two by two.

S2, two expandable profile liners are placed into the two horizontal clamping mechanisms 1 respectively, and the horizontal clamping mechanisms 1 are leveled, i.e., through the action of the first hydraulic cylinder 13, ensuring the central axes of the two expandable profile liners align on the same central axis.

S3, the beveled edges of the two expandable profile liners to be welded are cleaned, i.e., oil stains, rust, and other contaminants are removed from the beveled edges of the profile liners to ensure welding quality.

S4, inserting the two expandable profile liners into the clamping and butt-joining mechanism 3, while maintaining a predetermined welding gap between the beveled edges of the two expandable profile liners to be welded; at this time, the first pneumatic grippers 17 and third pneumatic grippers 33 actuate to effectively clamp and position the expandable profile liners.

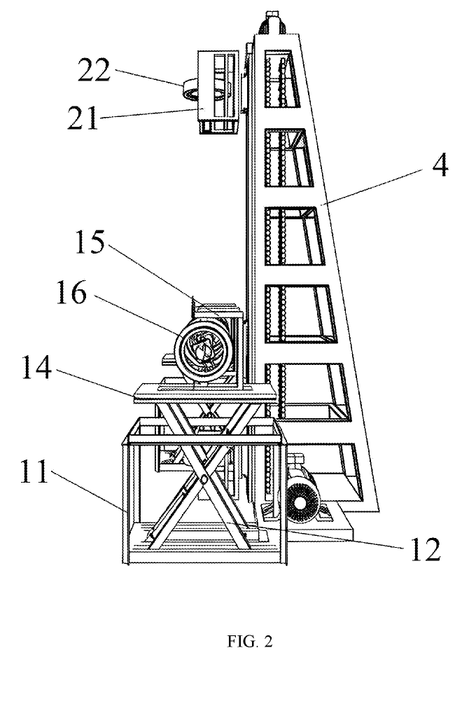

S5, with reference to FIG. 1 and FIG. 2, the horizontal automated welding is performed through the clamping and butt-joining mechanism 3; through the first movable ring 18 of the first annular guide rail 16 driving the first pneumatic grippers 17 to rotate and the third movable ring 36 of the third annular guide rail 32 driving the third pneumatic grippers 33 to rotate, the first pneumatic grippers 17 and third pneumatic grippers 33 may drive the expandable profile liners to rotate, enabling the manipulator 34 to drive the automated welding torch 35 to weld the welding position.

S6, after the horizontal automated welding is completed, the expandable profile liners are released from the first pneumatic grippers 17 and third pneumatic grippers 33, and the welded expandable profile liner string 46 is removed. Then, steps S2-S5 are repeated to obtain multiple groups of welded expandable profile liner strings.

S7, relocating the welding apparatus to the wellhead and adjusting the clamping and butt-joining mechanism to vertical welding mode by rotating the third support plate 31 through 90° via the electric turntable 44, thereby enabling vertical welding operations.

S8, firstly, one end of a group of welded expandable profile liner string is lowered into the wellhead, then the other end of this group of welded expandable profile liner string is installed onto the vertical clamping mechanism 2 located below; and this welded expandable profile liner string is clamped.

S9, another group of welded expandable profile liner string is placed onto the vertical clamping mechanism 2 located above the clamping and butt-joining mechanism 3; and the other group of welded expandable profile liner string is clamped.

S10, cleaning the beveled edges at the opposing ends of the two welded expandable profile liner strings by removing oil stains, rust, and other contaminants; then actuating the second hydraulic cylinder to maintain a predetermined welding gap between the opposing ends of the two expandable profile liner strings.

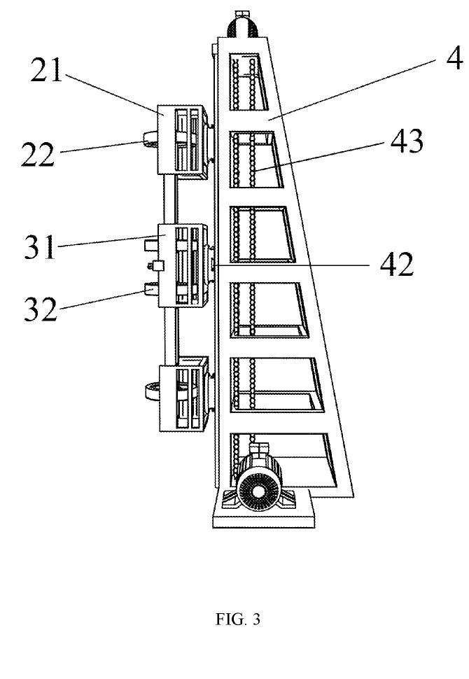

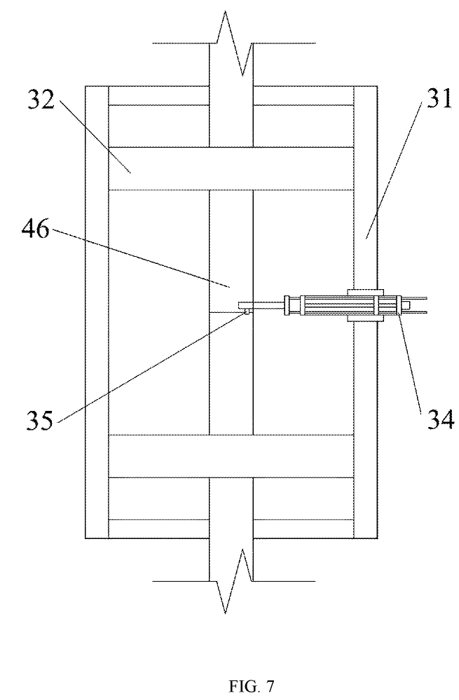

S11, with reference to FIG. 3 and FIG. 7, the vertical automated welding is performed through the clamping and butt-joining mechanism 3; through the second movable ring 24 of the second annular guide rail 22 driving the second pneumatic grippers 23 to rotate and the third movable ring 36 of the third annular guide rail 32 driving the third pneumatic grippers 33 to rotate, the second pneumatic grippers 23 and third pneumatic grippers 33 may drive the expandable profile liners to rotate, enabling the manipulator 34 to drive the automated welding torch 35 to weld at the welding position; after vertical automated welding is completed, a non-destructive testing device is used to inspect the weld quality, and the welded expandable profile liner strings are lowered into the well after confirming compliance.

S12, upon completion of vertical automated welding, lowering the welded expandable profile liner strings into the well through the wellhead. The lower vertical clamping mechanism 2 clamps one end of the expandable profile liner extending from the wellhead. The second hydraulic cylinder actuates to separate the two second support plates 21, then the third pneumatic grippers 33 release. The chain conveyor system drives the third support plate 31 upward until it approaches the upper second support plate 21, whereupon the third pneumatic grippers 33 clamp the expandable profile liner string. The second pneumatic grippers 23 then release, and the chain conveyor system drives the third support plate 31 downward, pushing the welded expandable profile liner string into the wellhead. When the end of the expandable profile liner string extending from the wellhead is positioned between the lower second pneumatic grippers 23 and third pneumatic grippers 33, the lower vertical clamping mechanism 2 clamps this end, and another welded expandable profile liner string is installed onto the upper vertical clamping mechanism 2 for continued welding.

S13, the steps S10 to S12 are repeated to complete the vertical welding and lowering into the well for all the expandable profile liner strings; subsequent downhole operations may then be performed.

In the description of the present disclosure, it should be understood that the terms “longitudinal”, “transverse”, “up”, “down”, “front”, “back”, “left”, “right”, “vertical”, “horizontal”, “top”, “bottom”, “inside”, “outside”, etc. indicate orientation or positional relationships based on the orientation or positional relationships shown in the accompanying drawings, only for the convenience of describing the present disclosure, and do not indicate or imply that the device or element referred to must have a specific orientation, be constructed and operated in a specific orientation, and therefore cannot be understood as a limitation of the present disclosure.

The above-mentioned embodiments only describe the preferred mode of the present disclosure, and do not limit the scope of the present disclosure. Under the premise of not departing from the design spirit of the present disclosure, various modifications and improvements made by one of ordinary skill in the art to the technical solution of the present disclosure should fall within the protection scope defined by the claims of the present disclosure.

1. An automated horizontal and vertical butt welding apparatus for expandable profile liners, comprising: a bracket (4) functioning as a basic lifting frame (11), wherein both lower sides of the bracket (4) are respectively provided with horizontal clamping mechanisms (1) for horizontally positioning the expandable profile liners, a clamping and butt-joining mechanism (3) for welding two interfaces of the expandable profile liners is arranged between the two horizontal clamping mechanisms (I), upper and lower sides of the clamping and butt-joining mechanism (3) are respectively provided with vertical clamping mechanisms (2) for vertically positioning the expandable profile liners, the clamping and butt-joining mechanism (3) is rotatably connected to an adjustment mechanism for controlling a rotation angle of the clamping and butt-joining mechanism (3), the adjustment mechanism is fixedly connected to a driving mechanism, and the driving mechanism is fixedly connected to the bracket (4);
the clamping and butt-joining mechanism (3) comprises a third support plate (31) rotatably connected to the adjustment mechanism, one end of the third support plate (31) away from the adjustment mechanism is internally symmetrically and fixedly connected with fixed rings of third annular guide rails (32), and an inner wall of a third movable ring (36) within each of the third annular guide rails (32) is symmetrically and fixedly connected with third pneumatic grippers (33);
a manipulator (34) is installed on the one end of the third support plate (31) away from the adjustment mechanism, and an automated welding torch (35) is installed on one end of the manipulator (34) away from the third support plate (31); and
each of the vertical clamping mechanisms (2) comprises a second support plate (21) slidably connected to the bracket (4), one end of the second support plate (21) away from the bracket (4) is internally fixedly connected with a fixed ring of a second annular guide rail (22), and an inner wall of a second movable ring (24) within the second annular guide rail (22) is symmetrically and fixedly connected with second pneumatic grippers (23).

2. The automated horizontal and vertical butt welding apparatus for expandable profile liners according to claim 1, wherein each of the horizontal clamping mechanisms (1) comprises a lifting frame (11), X-shaped supports (12) are symmetrically arranged within the lifting frame (11), ends of the X-shaped supports (12) are slidably connected to a bottom of the lifting frame (11), other ends of the X-shaped supports (12) are slidably connected to a top plate (14), and a first clamping part is arranged on one end of the top plate (14) away from the X-shaped supports (12).

3. The automated horizontal and vertical butt welding apparatus for expandable profile liners according to claim 2, wherein the other ends of the X-shaped supports (12) close the top plate (14) are fixedly connected to a piston end of a first hydraulic cylinder (13), a fixed end of the first hydraulic cylinder (13) is fixedly connected to the bottom of the lifting frame (11), and the first hydraulic cylinder (13) is arranged obliquely.

4. The automated horizontal and vertical butt welding apparatus for expandable profile liners according to claim 2, wherein the first clamping part comprises a first support plate (15) fixedly connected to the top plate (14), a fixed ring of a first annular guide rail (16) is fixedly connected in the first support plate (15), and first pneumatic grippers (17) are symmetrically and fixedly connected to an inner wall of a first movable ring (18) within the first annular guide rail (16).

5. The automated horizontal and vertical butt welding apparatus for expandable profile liners according to claim 1, wherein the adjustment mechanism comprises a movable block slidably connected to the bracket (4), one end of the movable block facing the third support plate (31) is fixedly connected to a fixed end of an electric turntable, and a movable end of the electric turntable is fixedly connected to the third support plate (31)

6. The automated horizontal and vertical butt welding apparatus for expandable profile liners according to claim 5, wherein the driving mechanism comprises a chain conveyor belt for controlling vertical lifting of the third support plate (31), the chain conveyor belt is installed inside one side of the bracket (4) away from the third support plate (31), and the movable block is fixedly connected to a chain of the chain conveyor belt.

7. An automatic horizontal and vertical butt welding method for expandable profile liners. based on the automatic horizontal and vertical butt welding apparatus according to any one of claim 1-claim 6, comprising following steps:
S1, determining a number of the expandable profile liners to be welded based on a length of a complex and isolation well section downhole, and performing welding on the expandable profile liners in pairs through horizontal welding:
S2, placing two of the expandable profile liners into the fayo horizontal clamping mechanisms (1) respectively, and leveling the horizontal clamping mechanisms (1) to enable central axes of the two expandable profile liners to lie on a same central axis;
S3, cleaning beveled edges of the two expandable profile liners to be welded;
S4, inserting the two expandable profile liners into the clamping and butt-joining mechanism (3), and maintaining a welding allowance between the beveled edges of the two expandable profile liners to be welded;
S5, performing horizontal automated welding through the clamping and butt-joining mechanism (3);
S6, after the horizontal automated welding is completed, removing a welded expandable profile liner string, then repeating the step S2 to the step S5 to obtain a plurality of groups of welded expandable profile liner strings;
S7, moving the welding apparatus to a wellhead, and adjusting the clamping and butt-joining mechanism to a vertical welding mode;
S8, first lowering one end of one of the groups of welded expandable profile liner strings into the wellhead, then installing another end of the welded expandable profile liner string onto the vertical clamping mechanism (2) at the lower side;
S9, placing another of the groups of welded expandable profile liner strings onto the vertical clamping mechanism (2) at the upper side of the clamping and butt-joining mechanism (3);
S10, cleaning beveled edges at opposing ends of the til groups of welded expandable profile liner strings;
S11, performing vertical automated welding through the clamping and butt-joining mechanism (3), then using a non-destructive testing device to inspect weld quality, and lowering into a well after confirming compliance;
S12, after the welding is completed, lowering the welded expandable profile liner string into the well through the wellhead, using the vertical clamping mechanism (2) at the lower side to clamp one end of the welded expandable profile liner string extending out of the wellhead, then installing yet another of the groups of welded expandable profile liner strings onto the vertical clamping mechanism (2) at the upper side, and continuing the welding; and
S13, repeating the step S10 to the step S12 to complete the vertical automated welding and lowering into the well for the groups of welded expandable profile liner strings; and then performing subsequent downhole operations.
